(19) United States
(12) Patent Application Publication
(10) Pub. No.: US 2018/0276592 A1
(43) Pub. Date: Sep. 27, 2018

(54) Talent Employment Methods and Systems

(71) Applicant: Yonir Technologies Ltd., Modi'in-Maccabim-Re'ut (IL)

(72) Inventors: Nir Arnesti, Givon HaHadasha (IL); Yossef Halfon, Givon HaHadasha (IL)

(73) Assignee: Yonir Technologies Ltd., Modi'in-Maccabim-Re'ut (IL)

(21) Appl. No.: 15/933,457

(22) Filed: Mar. 23, 2018

Related U.S. Application Data
(60) Provisional application No. 62/475,349, filed on Mar. 23, 2017.

(51) Int. Cl. G06Q 10/06; G06Q 50/00; G06N 5/04; G06Q 10/10

(52) U.S. Cl. CPC G06Q 10/063112; G06Q 10/1053; G06N 5/04; G06Q 50/01

(57) ABSTRACT

Systems and methods are provided for facilitating a social media network, implemented by an information-handling system, including generating by an inference engine, according to feedback regarding prior job engagements, an automatic recommendation including a match of a selected worker and a selected job and including a recommended hiring framework.

### FIELD OF THE INVENTION

The present invention relates to methods and systems for automated business practices and in particular for automated employment arrangements.

### BACKGROUND OF THE INVENTION

Organizations or individuals who need to perform jobs have multiple options for recruiting and engaging workers. They may seek full-time or part-time workers, or may contract out the work, turning to intermediaries, such as contractors, outsourcing firms, or job placement agencies. For single projects, an employer may prefer temporary workers hired only for the duration of a project. Employers may therefore prefer to engage workers through outsourcing firms, which may assume many of the typical hiring and lay-off costs associated with employees. An outsourcing firm's cost structure may provide more flexibility to matching worker availability to job requirements.

Known systems for recruiting and engaging workers include a variety of automation methods. For example, U.S. Pat. No. 5,978,768 to McGovern, et al., describes an interactive computer-driven employment recruiting service that enables an employer to advertise available positions on the Internet, receive and screen resumes, and automatically notify candidates when a suitable position is available. U.S. Pat. No. 7,502,748 to Baldwin, et al., describes a system for matching employment candidates to employment positions by measurement of personality traits and optionally interests. U.S. Pat. No. 7,502,804 to Cohen describes a system for selecting a candidate for a work position using a candidate's performance data along with a set of candidate rules, to produce a performance rating.

U.S. Pat. No. 8,346,569 to Schneiderman, et al., describes a system and method for creating a dynamic customized employment profile. U.S. Pat. No. 8,036,924 to Putnam, et al., describes a method of recommending industries for a job seeker's job search.

### SUMMARY

The present invention provides methods and systems for implementing a hiring framework as a social media network bringing together workers and job offerors. Embodiments provide means for enabling job offerors and workers to find suitable relationships in an efficient manner. Employers can improve their time and costs for finding appropriate workers, especially in environments suitable for part-time and temporary workers.

A predictive engine determines job/worker matches including hiring frameworks by applying an optimization algorithm based on successes of prior matches. Additional features of systems provided by embodiments of the present invention may include: social media marketing of the service; website or mobile app interfaces for workers, job offerors and contractors; interfaces for enrollment, for job searching, and for updating job completion status; job engagement for multiple workers; alerts of job matches delivered to job offerors and to workers; algorithmic matching; jobs offered on hourly basis, or per job; calendars for scheduling job interviews; feedback surveys of job offerors and workers; feedback used for setting worker rating and used for estimating compensation range; paid ad campaigns for workers; comparative salary information; service center/call center; automated calculation of alternative hiring frameworks, comparing costs, including tax implications after expenses.

According to embodiments of the present invention, a computer-based method of matching workers and jobs is provided, implemented by at least one processor having at least one memory storage on which is stored computer-readable instructions, which, when executed by the processor, cause the processor to perform the method. The method may include receiving multiple job profiles of jobs to be performed for multiple respective job offerors, receiving multiple worker profiles for multiple respective workers seeking jobs, and generating by an inference engine, according to feedback regarding prior job engagements, an automatic recommendation, including a match of a selected worker and a selected job, and including a recommended hiring framework, wherein the selected worker and the selected job are chosen from among the respective multiple job offerors and workers.

After generation of the automatic recommendation, the processor may receive: pre-job feedback from the worker and the job offeror regarding an agreement process for setting terms of the engagement; on-job feedback regarding the worker's hours while performing the job in conjunction with records of job progress; and post-job feedback from the worker and the job offeror regarding success of the engagement following completion of the job. The processor may apply the pre-job, on-job, and post-job feedback in modeling a revision of the inference engine and may apply the revised inference engine to make a subsequent automatic recommendation for a subsequent job match, including a corresponding, subsequent recommended hiring framework.

In some embodiments, the job profile of the selected job includes a plurality of alternative hiring frameworks, the worker profile of the selected worker includes a plurality of alternative hiring frameworks, including at least two of the alternative hiring frameworks of the job profile, and generating by an inference engine an automatic recommendation including a recommended hiring framework includes performing a cost analysis of each of the alternative hiring frameworks and providing a recommendation including costs and potential difficulties of implementing the recommended hiring framework. Factors of the cost analysis may include net costs of the frameworks after taxes, overhead, and insurance.

In some embodiments, the worker profile of the selected worker may be updated by the post-job feedback and applied by the inference engine to perform a new automatic recommendation matching the selected worker with a new job.

The recommended hiring framework may be a back-to-back framework comprising a first employment relationship between the worker and a contractor, and a second employment relationship between the contractor and the job offeror. Alternatively, the recommended hiring framework may be a subcontracting of the job to the worker by a contractor, and wherein implementing the framework comprises reporting an independent contractor status of the worker to a government authority. Alternatively, the recommended hiring framework may be a formal hiring of the worker by a contractor to perform the job, and wherein implementing the framework comprises reporting a formal hiring of the worker by the contractor to a government authority.

In further embodiments of the present invention, a computing system is provided including at least one processor and at least one memory communicatively coupled to the at least one processor comprising computer-readable instructions that when executed by the at least one processor cause the computing system to implement a method for recommending job matches, including: receiving multiple job profiles of jobs to be performed for multiple respective job offerors; receiving multiple worker profiles for multiple respective workers seeking jobs; and generating by an inference engine, according to feedback regarding prior job engagements, an automatic recommendation, including a match of a selected worker and a selected job, and including a recommended hiring framework, wherein the selected worker and the selected job are chosen from among the respective multiple job offerors and workers.

The computer system may be further configured to perform, after generation of the automatic recommendation, steps that include receiving pre-job feedback from the worker and the job offeror regarding an agreement process for setting terms of the engagement; receiving on-job feedback regarding the worker's hours while performing the job in conjunction with records of job progress; receiving post-job feedback from the worker and the job offeror regarding success of the engagement following completion of the job; applying the pre-job, on-job, and post-job feedback to model a revised inference engine; and applying the revised inference engine to make a subsequent automatic recommendation for a subsequent job match including a corresponding subsequent hiring framework.

Other features and advantages of the invention will be apparent from the following detailed description, and from the claims.

### BRIEF DESCRIPTION OF THE DRAWINGS

In the following detailed description of various embodiments, reference is made to the following drawings that form a part thereof, and in which are shown by way of illustration specific embodiments by which the invention may be practiced, wherein:

FIG. 1 is a flow diagram schematically illustrating a method for engaging workers in jobs, according to some embodiments of the invention; and

FIG. 2 is a block diagram, schematically illustrating a system for employment matching and tracking, according to some embodiments of the invention.

### DETAILED DESCRIPTION

The description below covers several embodiments of the present invention, but these should not be construed as limitations on the scope of the invention, rather as exemplifications. Those skilled in the art will envision other possible variations that are within the scope of the invention.

The invention relates generally to creating and supporting a social media network that facilitates interactions within a large community of job offerors and workers.

Job offerors seek workers for implementing projects or jobs (collectively referred to herein below as jobs). Job offerors may be the firms, organization, or individual who will own the results of the jobs, or contractors, temporary employee agencies, or other intermediaries. When a job offeror is an intermediary, the owner of the job results is a client of the contractor and is referred to hereinbelow as the client.

Workers, or “talent”, are people who have the skills and capabilities for implementing the jobs. Hereinbelow, workers who are seeking work are referred to hereinbelow as workers or “job seekers”.

An embodiment of the invention is a computer-based system, including interfaces and processes for matching jobs with workers, as well as for efficiently monitoring worker engagement. Feedback at multiple stages of the process improves a predictive engine that performs the job/worker matching process.

Interfaces to the application may be mobile or web-based interfaces. The computer-based system may be managed by an employment contractor, or by a third party who manages the system for multiple employment contractors. An employment contractor (hereinbelow “contractor) is an intermediary between workers and clients, that is, the contractor's customers. Some embodiments of the present invention may facilitate the matching of part-time workers with jobs or projects by facilitating employer-employee or contractor-subcontractor relationships between contractors and part-time workers.

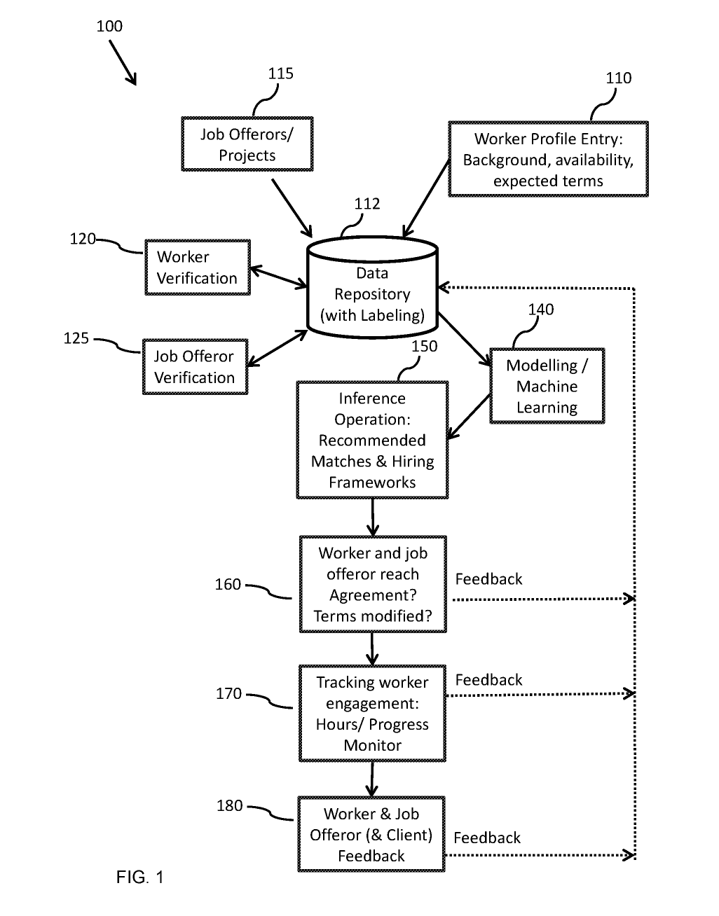

FIG. 1 is a flow diagram schematically illustrating a process 100 for matching workers to jobs, and for subsequent employment tracking, according to some embodiments of the invention. Steps of the process may be performed by the computer-based system described above, which may be configured to operate on a distributed and/or scalable configuration of computers.

At a step 110, a worker seeking a job (also referred to herein as a “job seeker”) registers for enrollment in a job matching and tracking system. In some embodiments, the system is targeted towards part-time or temporary job seekers. Step 110 generally follows steps whereby the job seeker first reviews marketing pages of a user interface of the system, which may be a website or mobile app. The system user interface may include options for reviewing possible jobs and projects that are available and which might suit the person's skills, background and availability. The system may also be configured to generate advertisements of available positions on multiple channels of social media, such as Facebook, with links provided from those social media channels to an app or webpage of the system that in turn provides a job seeker interface.

Also at step 110, the job seeker may enter initial identifying information, job skills, and availability. In addition, the worker may also begin the process of completing a “worker profile”, which may be updated subsequently. The worker profile may include a resume, a list of skills, recommendations, as well as more general personal details, such as a personality survey. Availability may be specified by means of a calendar provided by the system interface. Availability may also be specified by hours, especially when the job seeker is seeking part-time work, such as a second job that could be performed before or after the hours of the primary job. Other availability parameters may include limitations related to geographic location, mobility, and physical limitations.

The job seeker may also enter hiring framework preferences, that is, preferences for the type of hiring framework by which the worker would like to perform the job. Alternative hiring frameworks may include an option for the worker to be a legal employee of a contractor or directly with the contractor's client, or for the worker to be an independent subcontractor, either for a job offeror or the client.

The job seeker may enter expected compensation as well. The job seeker may be assisted in setting expected compensation by comparative survey information that the system provides related to similar work on a similar part-time or full-time job, in the job seeker's industry or similar industry. Payment terms may include various stipulations, such as desired salary range and frequency of payments. In one embodiment, job seekers are required to stipulate hourly wages and jobs are priced per-hour. In further embodiments, such terms are flexible, and jobs may be priced per job. Generally all inputs by the job seeker can be updated as desired by the job seeker.

A data repository 112 is a repository for all worker profile data entered by the worker at the step 110. The data repository 112 also maintains data regarding prior employment engagements, with indications regarding the satisfaction of the various parties with respect to the engagements. All the data in the data repository 112 may be used as a data set to generate an inference engine for work/job matches, as described further hereinbelow.

At a step 115, job offerors may enter job profiles describing the jobs they have available. Job openings may be for part-time workers, and may be for positions to be paid on an hourly basis. In further embodiments, jobs may be priced on a “per job” basis or may be for full-time work for a limited period of time. Job profiles may include the expected location of the work, which could be on or off-site, depending on the type of activity. Jobs openings may also be “posted” for jobs that require multiple workers. (In some cases, jobs may be for workers who would be viewed by government authorities as being statutory employers if they were to work as independent contractors.) Job offerors may also enter preferred types of hiring frameworks, as described above.

The job offerors may also input additional initial information about their business. Jobs offers may also be entered into the system automatically by a web crawler, which discovers public postings of jobs on social networks or sites that list job tenders.

The system provides user interfaces by which the job owners and the workers can maintain the profiles they have entered and search for matches between the profiles they have entered and profiles that suit their requirements. Like the worker profile, all job profiles are entered into a data repository 112.

After the step of job seeker registration, the system, at a step 120, begins an initial verification of the worker profile data, that is, a process of confirming information such as prior employment and other details such as contact information. Verification may include accessing external sources after authorization for such access is given by the job seeker. For certain positions, on-line exams may be required of the job seeker.

A job offeror verification process 125 may also be performed for job offerors, similar to the worker verification of step 120. For example, work conditions (safety, health, etc.) of the job offeror may be checked. The contractor may also enter into detailed contract arrangements with each job offeror, on a supplier-client, or service provider-client basis.

Following the various steps of verification, the worker profile may be made public, at which point a process of matching the worker profile with job profiles begins. The job seeker, now enrolled as a “worker”, may manually search a database of job profiles. Conversely, job offerors may manually search the database of worker profiles.

The system may also be configured to execute “promotions” of workers and/or job openings. Promotional efforts may be made upon payment for such a service by a worker or job offeror, or may be provided as a bonus for members of the system. Promotions may include providing advertisements on user interfaces of the system, as well as pushing promotions to the social media described above.

In further embodiments, at a step 150, an inference engine matches workers and jobs, that is, the inference engine makes a recommendation of a match and recommends a corresponding hiring framework. The inference engine is typically a system generated by a machine learning process 140, based on data in the data repository 112. The machine learning process extracts features of prior job/worker engagements, including feedback provided at various stages of those engagements, to generate an inference engine designed to create recommendations for successful job/worker matches, including successful hiring frameworks. The machine learning process may utilize known tools, such as the Scikit-Learn, python-based, machine learning environment.

In some embodiments, a hiring framework recommendation may be complemented by an additional feature of the inference engine termed a framework analyzer. Multiple parameters may be consider by this framework analyzer, including how hiring frameworks may have contributed to, or detracted from, previous successful and unsuccessful worker engagements. In addition, cost parameters preset by the contractor for different frameworks may be considered, including how the costs may be divided between the contractor and the worker. For example, contractor costs may be lower when the worker is an independent subcontractor, because various tax and insurance obligations are not placed on the contractor. The system may be configured to recommend offering the worker higher compensation if the independent subcontractor framework is selected, thereby offsetting costs that the worker would take upon himself. The framework analyzer will consider the relevant ramifications of government regulations. The output of the inference engine may provide the multiple considerations of costs and potential difficulties of implementing different frameworks.

When a match between a worker profile and a job profile is determined, the worker and job offeror may be notified of the recommendation and may meet to discuss terms and to determine their mutual suitability, at a step 160. If terms, hours, location, talent skill set, etc. are deemed appropriate by both parties, the parties confirm the engagement. The parties also provide feedback, referred to hereinbelow as “pre-job” feedback” regarding the agreement process. The pre job feedback is entered into the data repository 112. Pre-job feedback may include data on the terms concluded in the agreement, as well as other issues that each party sees as contributing or detracting from the agreement process. Similarly, pre-job feedback regarding a failed hiring process is also added to the data repository 112. The pre-job feedback process is typically automated by the system web-based forms for addressing issues, which are provided to the participants. All issues of the pre-job feedback are entered into the repository as “features” that may be subsequently processed for improving the inference engine.

After the parties reach an agreement, a formal employment contract is generally completed between the worker and the job offeror. The hiring framework determined by the parties may be to hire the worker as an employee, requiring government reporting, such as notifications to tax authorities and social security. The system is configured to automatically generate some or all of the necessary notifications and documentation. If the agreement includes a client, for whom a contractor is performing work, the system may also register the client, for the client feedback.

If the decision is made to engage the worker as a subcontractor, then the contractor may issue a purchase order to the worker. Also, the contractor may receive a similar purchase order and/or contract from his client, making the two relationships back-to-back relationships. In parallel, the worker may need to complete legal requirements, such as government tax registration and health insurance registration in order to work as an independent contractor. The system may include link and services to assist the worker with these tasks.

After completely the legal processes, at a step 170, which may be an on-going, iterative step, the worker performs the job, generally keeping track of hours. Depending on the hiring framework, the worker may be paid per hour, per day, or per job, etc. The system may include interfaces, such as mobile application or web-based interfaces to facilitate the recording of hours and work progress. Work progress may be defined as the accomplishment of milestones or as estimates of percent of a job completed. The system may also provide services such as enabling a worker, working as an independent subcontractor, to generate invoices to a contractor or client. The hours and work progress recorded during the step 170 may be provided as “on job” feedback to the data repository 112, and may subsequently be incorporated into the machine learning process 140, as additional features of the given worker/job engagement.

In some hiring frameworks, the job offeror may be a job placement agency that receives a fee, as a margin of the transaction, or as a fixed fee. The system may also enter details of these terms in the data repository 112.

At a step 180, the job is completed. Subsequently, post-job feedback on the engagement may be provided by the job offeror and the worker, as well as the client, if the job offeror is not the job owner. Feedback is entered into the data repository 112. The post-job feedback may be applied by the system to provide scores of the worker and/or job offeror for subsequent engagements. Scoring may be utilized to an algorithm that provides a recommended pay scale for the worker, for example.

In addition, feedback regarding the success of the engagement may be used by the machine learning process 140 to improve the inference engine for all subsequent matches and framework recommendations. That is, all features of the engagement, including the characteristics of the worker, the job, and the job offeror, as well as the feedback on the negotiations and terms reached, the worker tracking, and the post-job feedback are correlated with the final determination of the success of the engagement to improve subsequent recommendations of the inference engine.

The worker may begin again the job search process by returning to step 110, while also continuing to update calendar availability, resume, and other profile details.

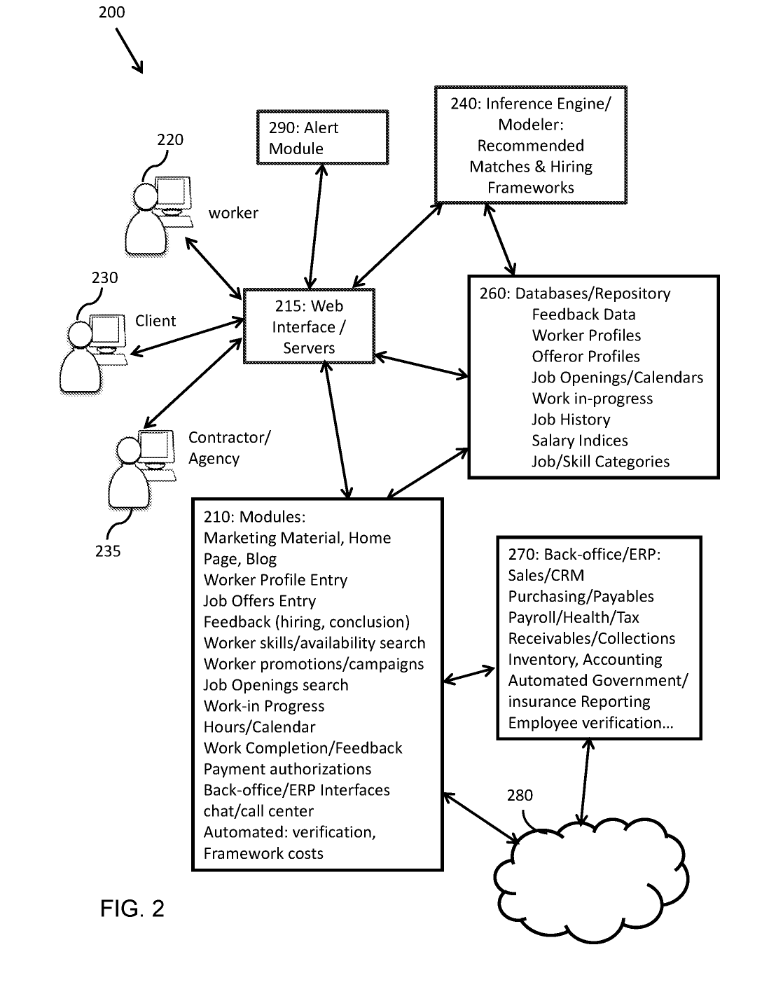

FIG. 2 is a block diagram, schematically illustrating a system 200 for matching workers to job openings and for engaging workers, according to some embodiments of the present invention. The system includes modules 210 and one or more interface servers 215 that are configured to implement processes including process 100 described hereinabove with respect to FIG. 1. The system also includes an inference engine and machine learning modeler 240, which performs the steps 140 and 150 as described above. The system may be implemented as software on computing hardware, as described further hereinbelow.

Modules 210 include a large range of modules configured to perform functions that are described hereinbelow. Some of these functions are also related to the types of user access described above with respect to the process 100. For example, marketing modules include software to generate marketing pages that will appear on interfaces accessed by visitors to a website or mobile app interface of the system, or on social media channels. Marketing modules may include modules for maintaining forums and blog pages. Modules may also manage promotions, as described above.

Other interface modules include modules for generating the screens used by workers and others accessing the system. Such interfaces are generally accessed through the interface servers 215 from access points 220, 230, and 235, the access points respectively for a worker, a client/job owner, and a contractor/employment agency. Generally these are computer access points such as mobile devices, desktop computers, or other network-connected interfaces.

Access interface screens include screens by which workers and job offerors register enrollment, enter profiles, including worker availability, and perform searches, as described above. Similarly, screens may be generated for job progress tracking and recording work hours (including time stamping time-in and time-out). Interfaces may be provided to customer service functions, generally provided by the contractor, such as a call center.

The system also includes databases 260 that are accessed by the modules for storing and retrieving data such as: worker data, including worker profiles, and job offeror data, including job profiles, and job tracking and status. Generally, historical data regarding all data and transactions. Relevant indices and comparative databases are maintained, such as a database of comparative industry salaries. Databases also include the data repository 112, which is used by the machine learning modeler described above.

The system also includes automated modules that operate asynchronously. Automated verification of employee data, such as background checks run against external databases may be performed once a worker has entered his profile and as a prerequisite step for the workers completion of enrollment. A module for automated job matching may run and provide alerts (such as SMS, email, or messaging alerts) through an alert module 290. Once a worker and a job offeror have been matched, a module may be executed implementing the hiring framework analyzer described above with respect to step 150 of process 100. Input to the framework analyzer may be include details of a specific job and job offeror, the jurisdiction, the worker and job profiles, and additional manual data entered by the worker, job offeror and contractor. The output may include reports distributed to one or more of the parties.

Further automated modules may include automated reporting and notifications to government authorities and insurance providers with respect to satisfying legal requirements of a given hiring framework. These communications are generally made over the Internet or other external networks 280.

An additional automated module, described above with respect to step 180, is a module for updating worker profiles and rating based on job offeror feedback after (or before) a job is completed.

Modules described above are generally in communications with back-office/ERP systems that track operations of the contractor, such as accounting, payroll, and sales systems.

All or part of the process 100 and the system 200 can be implemented as a computing system in digital electronic circuitry, or in computer hardware, firmware, software, or in combinations thereof. The computing system may have one or more processors and one or more network interface modules. Processors may be configured as a multi-processing or distributed processing system. Network interface modules may control the sending and receiving of data packets over networks. Security modules control access to all data and modules. All or part of the system and process can be implemented as a computer program product, tangibly embodied in an information carrier, such as a machine-readable storage device or in a propagated signal, for execution by, or to control the operation of, data processing apparatus, such as a programmable processor, computer, or deployed to be executed on multiple computers at one site or distributed across multiple sites. Memory storage may also include multiple distributed memory units, including one or more types of storage media.

Method steps associated with the system and process can be rearranged and/or one or more such steps can be omitted to achieve the same, or similar, results to those described herein. It is to be understood that the embodiments described hereinabove are cited by way of example, and that the present invention is not limited to what has been particularly shown and described hereinabove. Rather, the scope of the present invention includes variations and modifications thereof which would occur to persons skilled in the art upon reading the foregoing description and which are not disclosed in the prior art.

Other embodiments not specifically described herein are also within the scope of the following claims.

While this invention has been particularly shown and described with references to most preferred embodiments thereof, it will be understood by those skilled in the art that various changes in form and details may be made therein without departing from the scope of the invention encompassed by the appended claims.

1. A computer-based method of matching workers and jobs, implemented by at least one processor having at least one memory storage on which is stored computer-readable instructions, which, when executed by the processor, cause the processor to perform the method comprising:
receiving multiple job profiles of jobs to be performed for multiple respective job offerors;
receiving multiple worker profiles for multiple respective workers seeking jobs; and
generating by an inference engine, according to feedback regarding prior job engagements, an automatic recommendation, including a match of a selected worker and a selected job, and including a recommended hiring framework, wherein the selected worker and the selected job are chosen from among the respective multiple job offerors and workers.

2. The method of claim 1, further comprising, after generation of the automatic recommendation:
receiving pre-job feedback from the worker and the job offeror regarding an agreement process for setting terms of the engagement;
receiving on-job feedback regarding the worker's hours while performing the job in conjunction with records of job progress;
receiving post-job feedback from the worker and the job offeror regarding success of the engagement following completion of the job;
applying the pre-job, on-job, and post-job feedback in modeling a revision of the inference engine; and
applying the revised inference engine to make a subsequent automatic recommendation for a subsequent job match including a corresponding, subsequent, recommended hiring framework.

3. The method of claim 1, wherein the job profile of the selected job includes a plurality of alternative hiring frameworks, wherein the worker profile of the selected worker includes a plurality of alternative hiring frameworks, including at least two of the alternative hiring frameworks of the job profile, and wherein generating by an inference engine an automatic recommendation including a recommended hiring framework comprises performing a cost analysis of each of the alternative hiring frameworks and providing a recommendation including costs and potential difficulties of implementing the recommended hiring framework.

4. The method of claim 3, wherein factors of the cost analysis are net costs of the frameworks after taxes, overhead, and insurance.

5. The method of claim 1, wherein the worker profile of the selected worker is updated by the post-job feedback and applied by the inference engine to perform a new automatic recommendation matching the selected worker with a new job.

6. The method of claim 1, wherein the recommended hiring framework is a back-to-back framework comprising a first employment relationship between the worker and a contractor, and a second employment relationship between the contractor and the job offeror.

7. The method of claim 1, wherein the recommended hiring framework is a subcontracting of the job to the worker by a contractor, and wherein implementing the framework comprises reporting an independent contractor status of the worker to a government authority.

8. The method of claim 1, wherein the recommended hiring framework is a formal hiring of the worker by a contractor to perform the job, and wherein implementing the framework comprises reporting a formal hiring of the worker by the contractor to a government authority.

9. A computing system comprising:
at least one processor; and
at least one memory communicatively coupled to the at least one processor comprising computer-readable instructions that when executed by the at least one processor cause the computing system to implement a method for recommending job matches, comprising:
receiving multiple job profiles of jobs to be performed for multiple respective job offerors;
receiving multiple worker profiles for multiple respective workers seeking jobs; and
generating by an inference engine, according to feedback regarding prior job engagements, an automatic recommendation, including a match of a selected worker and a selected job, and including a recommended hiring framework, wherein the selected worker and the selected job are chosen from among the respective multiple job offerors and workers.

10. The system of claim 9, wherein the computer system is further configured to perform, after generation of the automatic recommendation, steps including:
receiving pre-job feedback from the worker and the job offeror regarding an agreement process for setting terms of the engagement;
receiving on-job feedback regarding the worker's hours while performing the job in conjunction with records of job progress;
receiving post-job feedback from the worker and the job offeror regarding success of the engagement following completion of the job;
applying the pre-job, on-job, and post-job feedback to model a revised inference engine; and
applying the revised inference engine to make a subsequent automatic recommendation for a subsequent job match including a corresponding, subsequent, recommended hiring framework.
